(19) United States
(12) Patent Application Publication
(10) Pub. No.: US 2022/0099278 A1
(43) Pub. Date: Mar. 31, 2022

(54) ILLUMINATED ARCHITECTURAL COVES FOR BUILDING ENVIRONMENTS

(71) Applicant: CIMA NETWORK, INC., CHALFONT, PA (US)

(72) Inventor: Brad Koerner, Amsterdam (NL)

(21) Appl. No.: 17/475,671

(22) Filed: Sep. 15, 2021

Related U.S. Application Data
(60) Provisional application No. 63/083,231, filed on Sep. 25, 2020.

(51) Int. Cl. F21V 19/00; F21V 15/01; E04B 9/00

(52) U.S. Cl. CPC F21V 19/008; F21Y 2115/10; E04B 9/006; F21V 15/01

(57) ABSTRACT

A prefabricated cove luminaire for installation onto ceilings or other architectural surfaces. The cove luminaire has a mounting mechanism configured to mount the cove luminaire onto the architectural surface. The cove luminaire further has a lower surface, an upper surface, and a side surface extending between the lower surface and the upper surface and separating the lower surface from the upper surface. In combination, the lower surface, the upper surface, and the side surface define an aperture. The cove luminaire still further has a light source positioned in the aperture and including optics that focus and direct the light rays emanating from the light source in specific patterns to ensure uniformity of the light distribution. Finally, the cove luminaire has a decorative feature located proximate or on the upper surface. Also disclosed is an integral lighting unit including the cove luminaire.

### RELATED APPLICATION

This application claims the benefit of priority to U.S. Provisional Patent Application Ser. No. 63/083,231, filed on Sep. 25, 2020, the contents of which are incorporated in this application by reference.

### TECHNICAL FIELD

The present disclosure relates generally to prefabricated ceiling cove luminaires and, more particularly, to prefabricated ceiling cove luminaires having high-quality lighting uniformity, straight and true fabrication details, and fast onsite installation features.

### BACKGROUND OF THE DISCLOSURE

Illuminated architectural coves are common decorative elements in modern building environments. Traditionally, architectural ceiling coves create a decorative faux-sky effect above decorative architectural molding or entablature. This architectural molding created soffits around the perimeter of the room where electric light sources could be concealed to create a faux illuminated sky effect. Such designs date back to the earliest days of electric lighting, typically found in grand, highly ornamental theaters.

In modern architectural use, architectural coves typically consist of an architectural surface or ceiling area raised over an architectural soffit. The architectural soffit is constructed in place as part of the wall or ceiling and creates a clearly defined visual feature in the space. The constructed soffit is usually designed to provide a concealed space on top of which various styles of electric lighting can be placed to illuminate the upper ceiling surface.

While ceiling coves are the most common application, architectural coves can be used in various positions within a space, including in vertical wall applications, in room divider applications, and others.

The challenge with architectural coves is that they are typically constructed in place using traditional architectural stud and wallboard construction, or via architectural millwork fabrication. However, this traditional method of constructing coves as built-in architectural features is costly and inefficient. Complicated framing, gypsum plaster work, coordinating multiple trades, and the installation of the actual electrical lighting units in confined spaces makes illuminated ceiling coves costly in new construction and difficult to install for retrofits without incurring major demolition and construction.

The architectural lighting industry has responded to the market demand for ceiling coves by creating a variety of luminaire styles that are intended to be placed in purpose-built architectural soffits or themselves are intended to partially construct a soffit (i.e., a light fixture built into an architectural extrusion that is integrated into the construction of the soffit). Examples of segmented luminaires for placement in soffits are available from Signify Netherlands B.V. of Eindhoven, The Netherlands (https://www.colorkinetics.com/global/products/productoverview#.htmlpage=1&filters=Application%2FConcealed%20Interior%20Linear%2C&page=1); Tempo LLC of Irvine, Calif. (https://tempollc.com/architecural/); Engineered Lighting Products, Inc. of El Monte, Calif. (https://www.elplighting.com/product/clc-led-series); and LED Linear USA of Niagara Falls, N.Y. (https://www.ledlinearusa.com/products/family/led-flexlights/?tx_ledlinear_product%5BonlySystem%5D=1&cHash=3446b4c8a254381340f0d013b52aa.25). Examples of luminaire/architectural extrusion hybrids are available from A-Light, an Acuity Brands company, of Oceanside, Calif. (https://www.alights.com/products/interior lighting/wall grazer/wgd9) and Vode Lighting LLC of Sonoma, Calif. (https://vode.com/zipwave-celing-cove-707). Finally, examples of light boxes are available from Signify Netherlands B.V. (https://www.colorkinetics.com/gloabal/onespace) and Moss Inc. of Elk Grove Village, Ill. (https://www.mossinc.com/products/?categories=34). No luminaire manufacturer has constructed a complete, ready-to-install luminaire solution, however, that replicates the key visual style and features of illuminated architectural coves without requiring complicated on-site construction.

### SUMMARY OF THE DISCLOSURE

Accordingly, there is a need for a prefabricated ceiling cove luminaire that can be quickly installed onto ceilings or other architectural surfaces and ensure high-quality lighting uniformity, straight and true fabrication details, and fast onsite installation. In addition, there is a need for a prefabricated ceiling cove luminaire that provides the opportunity for unique options like digitally printed or 3D relief upper surfaces, acoustic fabrics, and a variety of light engine options as well as a unique double-layer cove effect.

To meet these and other needs, and in view of its purposes, the present disclosure provides a prefabricated cove luminaire that can be quickly installed onto ceilings or other architectural surfaces. The cove luminaire has a mounting mechanism configured to mount the cove luminaire onto the architectural surface. The cove luminaire further has a lower surface, an upper surface, and a side surface extending between the lower surface and the upper surface and separating the lower surface from the upper surface. In combination, the lower surface, the upper surface, and the side surface define an aperture. The cove luminaire still further has a light source positioned in the aperture and including optics that focus and direct the light rays emanating from the light source in specific patterns to ensure uniformity of the light distribution. Finally, the cove luminaire has a decorative feature located proximate or on the upper surface.

The present disclosure also provides a prefabricated cove luminaire having high-quality lighting uniformity, straight and true fabrication details, and fast onsite installation features.

The present disclosure also provides a prefabricated cove luminaire having a unique double-layer cove effect.

It is to be understood that both the foregoing general description and the following detailed description are exemplary, but are not restrictive, of the disclosure.

### BRIEF DESCRIPTION OF THE DRAWING

The disclosure is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 shows a prefabricated or partially prefabricated architectural luminaire that replicates a constructed ceiling cove luminaire according to the present disclosure further depicting architectural mounting, a lower surface, an upper surface, a side surface, and a light source;

FIG. 2 shows a recess-mounted architectural luminaire with an architectural interface;

FIG. 3 shows an asymmetric architectural luminaire mounted in open air;

FIG. 4 shows an architectural luminaire having a decorative feature;

FIG. 5 is a perspective view of another embodiment of an architectural luminaire;

FIG. 6 shows an architectural luminaire having additional layers;

FIG. 7 shows an embodiment of the architectural luminaire having an inverted configuration;

FIG. 8 shows one embodiment of a pair of mount brackets that can be used to mount the architectural luminaire to an architectural surface;

FIG. 9 illustrates the two mount brackets shown in FIG. 8 aligned with an embodiment of the architectural luminaire;

FIG. 10 illustrates how the architectural luminaire slides into engagement with the mount brackets;

FIG. 11 illustrates the architectural luminaire fully engaging the mount brackets and an example fastener used to releasably attach the architectural luminaire to the mount brackets;

FIG. 12 shows the architectural luminaire attached to the mount brackets;

FIG. 13 is a schematic illustrating an integral lighting unit including an embodiment of the architectural luminaire;

FIGS. 14A, 14B, 14C, 14D, and 14E show various non-limiting options for the aesthetic displays illustrated in a top view of the architectural luminaire (above) and for the corresponding structures of a lighting unit illustrated in a schematic view (below);

FIG. 15 illustrates three, separate applications for the architectural luminaire as part of a room in a building environment;

FIG. 16 illustrates two, separate applications for the architectural luminaire as part of a common area in another building environment;

FIG. 17 illustrates two, separate applications for the architectural luminaire as part of a retail space in yet another building environment;

FIG. 18 shows that the architectural luminaire can be installed in open ceiling retail space in a further building environment;

FIG. 19 illustrates one example of how the architectural luminaire shown in FIG. 18 can be customized;

FIG. 20A shows an embodiment of the architectural luminaire having a single panel and FIG. 20B illustrates an alternative embodiment of the architectural luminaire having a large format with multiple panels separated by joint lines;

FIG. 21 illustrates an embodiment of the architectural luminaire as installed on a typical ceiling in two different office spaces;

FIG. 22 illustrates an embodiment of the architectural luminaire for which the decorative feature is a shadow 3D relief;

FIG. 23 illustrates five examples of decorative art displays created by digital printing that can form the decorative feature of the architectural luminaire 1;

FIG. 24 illustrates six examples of decorative art displays created by fabric layers or perforated ceiling panels that can also form the decorative feature of the architectural luminaire; and

FIG. 25 illustrates an embodiment of the architectural luminaire for which the decorative feature is a colored dual layer display.

### DETAILED DESCRIPTION OF THE DISCLOSURE

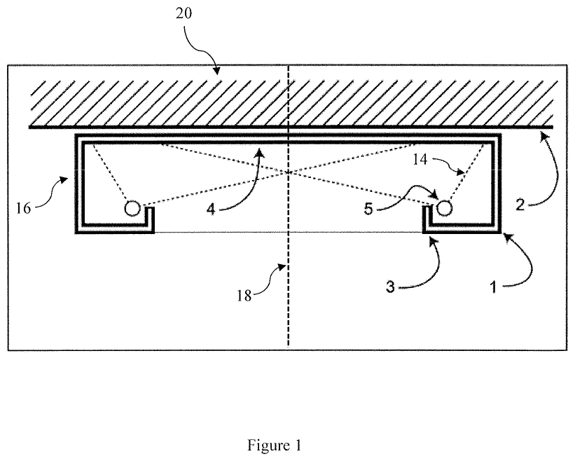

Referring now to the drawing, in which like reference numbers refer to like elements throughout the various figures that comprise the drawing, FIG. 1 shows a prefabricated or partially prefabricated architectural luminaire 1 that replicates a constructed architectural ceiling cove. As shown in FIG. 1, the architectural luminaire 1 is surface-mounted onto a solid architectural surface 20 using an architectural mounting 2. The architectural luminaire 1 has a lower surface 3, an upper surface 4, a side surface 16 extending between the lower surface 3 and the upper surface 4 and separating the lower surface 3 from the upper surface 4, and a light source 5. In combination, the lower surface 3, the upper surface 4, and the side surface 16 define an aperture.

The lower surface 3 can be constructed from a variety of materials including but not limited to metal, wood, glass, or any combination thereof. The lower surface 3 can be constructed in a variety of shapes and configurations including but not limited to linear, curved, or any combination thereof. As shown in FIG. 1, the lower surface 3 has two, opposed L-shaped edges, with an opening between the edges, and the architectural luminaire 1 is symmetrical about a vertical centerline 18.

As also shown in FIG. 1, the light source 5 is positioned in the aperture defined by the architectural luminaire 1 proximate to the L-shaped edges of the lower surface 3. Such a position allows the light source 5 to be concealed or at least partially concealed by the lower surface 3. The light source 5 illuminates upwards towards the upper surface 4, as depicted by the light rays 14. The light source 5 can include optics that focus and direct the light rays 14 emanating from the light source 5 in specific patterns to ensure uniformity of the light distribution across the upper surface 4 while minimizing the overall height of the architectural luminaire 1. Furthermore, the light source 5 may run continuously around the perimeter or only cover limited segments of the overall layout of the architectural luminaire 1.

The upper surface 4 acts as a reflector for the light rays 14 that emanate from the light source 5. The upper surface 4 primarily reflects the light rays 14 downward, through the opening between the edges of the lower surface 3, and out of the architectural luminaire 1. The upper surface 4 can be constructed from a variety of materials including but not limited to solid surfaces, porous or fibrous acoustic absorbing surfaces, stretched fabric, or any combination thereof

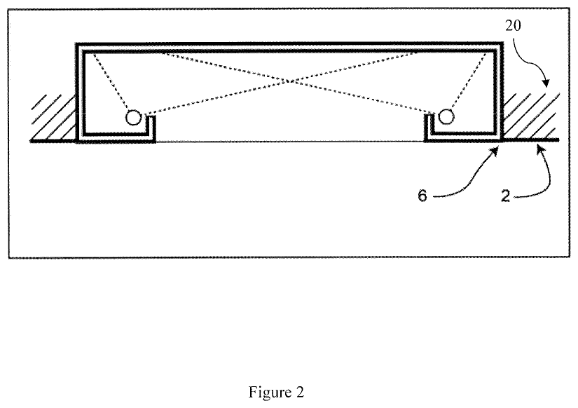

The architectural luminaire 1 can be mounted in one or more typical configurations. As shown in FIG. 1, the architectural luminaire 1 is surface-mounted onto the solid architectural surface 20. FIG. 2 illustrates a second configuration in which the architectural luminaire 1 is mounted into a recess in the solid architectural surface 20. The architectural luminaire 1 can be recessed into the solid architectural surface 20 at various pre-determined depths depending upon the application. (By “predetermined” is meant determined beforehand, so that the predetermined characteristic must be determined, i.e., chosen or at least known, in advance of some event.) An integral architectural interface 6 can be provided between the architectural luminaire 1 and the solid architectural surface 20 in the embodiment illustrated in FIG. 2. (By “integrated” or “integral” is meant a single piece or a single unitary part that is complete by itself without additional pieces, i.e., the part is of one monolithic piece formed as a unit with another part.) The architectural interface 6 engages the solid architectural surface 20 and, in certain mounting applications, the architectural interface 6 may be required. Such applications include but are not limited to trim for flush mounting, trim for accepting wall finishing media, trim for abutting architectural panel systems, or any combination thereof.

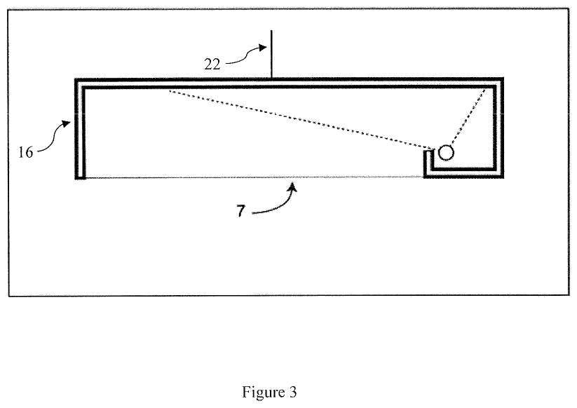

FIG. 3 illustrates a third mounting configuration for the architectural luminaire 1 in which the architectural luminaire 1 is mounted in open air. In one example embodiment, the architectural luminaire 1 is suspended in open air from the adjacent architectural surface 20 or from another structural element via a mounting hanger 22. Other suspension mechanisms are within the knowledge of a person of ordinary skill in the art of architectural luminaires. The embodiment of the architectural luminaire 1 illustrated in FIG. 3 is asymmetric; the lower surface 3 has only one L-shaped edge and the opening 7 is created between that edge and the opposite side surface 16.

The architectural luminaire 1 can be symmetric or asymmetric. The architectural luminaire 1 can also be rectilinear or non-rectilinear. Non-geometric configurations are also possible for the architectural luminaire 1. Thus, configurations suitable for the architectural luminaire 1 may include but are not limited to symmetric or asymmetric, rectilinear or non-rectilinear, geometric or non-geometric, or any combination thereof. More specifically, the overall architectural luminaire 1 may be configured in a variety of geometric shapes or sizes including but not limited to rectilinear, polygon, circular, linear, or any combination thereof. In addition, the overall architectural luminaire 1 may be configured in a non-geometric amorphous shape.

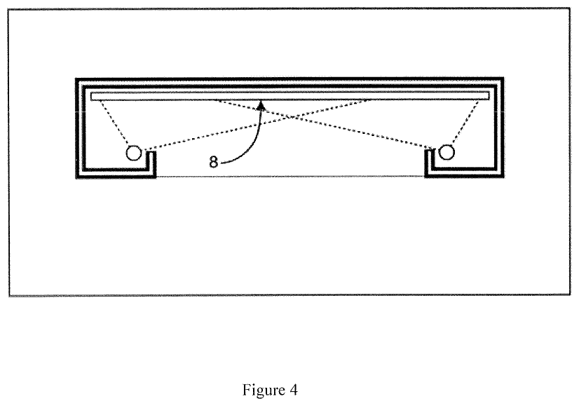

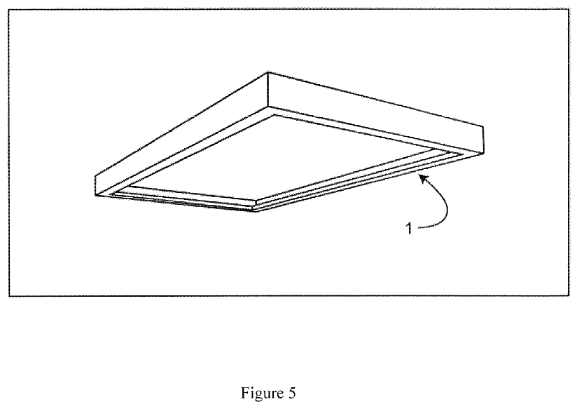

The embodiment of the architectural luminaire 1 shown in FIG. 4 includes a decorative feature 8. The decorative feature 8 can be located proximate the upper surface 4 in a variety of 2D media including but not limited to digital printed graphics, painted elements, decorative cut vinyl or plastic adhered to the upper surface 4, or any combination thereof. In addition, the decorative feature 8 can be featured on the upper surface 4 in a variety of 3D shapes or sculptural surfaces. FIG. 5 is a perspective view of another embodiment of the architectural luminaire 1.

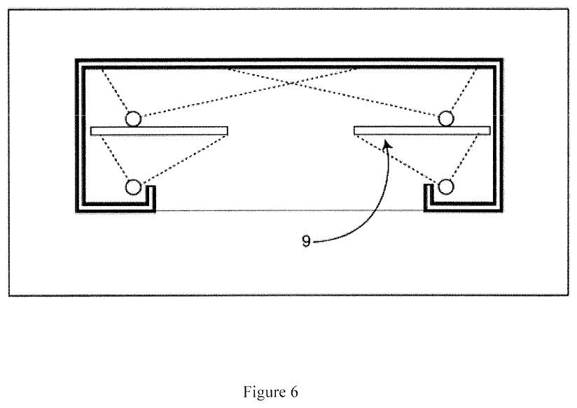

The architectural luminaire 1 can include additional layers 9 located within its aperture. FIG. 6 shows one embodiment of the placement of the additional layers 9. The additional layers 9 create a dimensional stack of apertures. Each layer of the additional layers 9 may have its own light source 5 (or multiple light sources 5) and individual control as well as its own decorative feature 8.

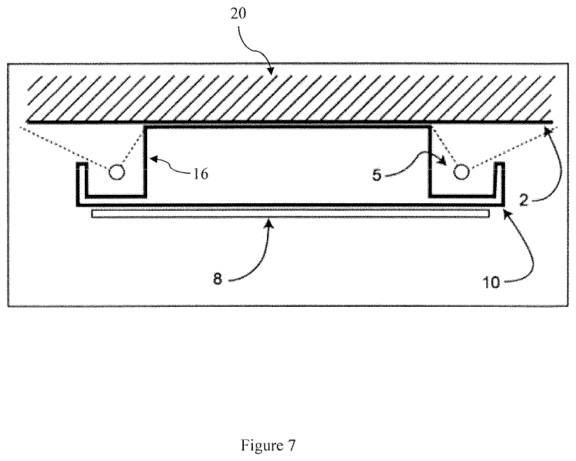

FIG. 7 shows an embodiment of the architectural luminaire 1 having an inverted configuration. In this configuration, the L-shaped edges 10 of the lower surface 3 extend outward away from the side surface 16 (rather than inward toward the side surface 16 as in previously illustrated embodiments). The light source 5 illuminates the outer perimeter of the architectural luminaire 1 and casts illumination onto the architectural surface 20 located above or behind the architectural luminaire 1 and to which the architectural luminaire 1 may be mounted.

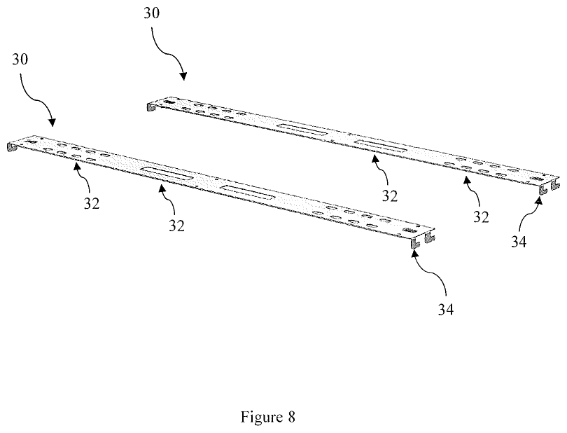

Mounting of the architectural luminaire 1 to the architectural surface 20, such as a typical ceiling, wall, or room divider, can be achieved using a variety of mechanisms. In a preferred embodiment, the mounting mechanism includes one or more “J-hook” mount brackets 30. FIG. 8 illustrates a suitable pair of mount brackets 30. Although two mount brackets 30 are depicted, one mount bracket 30 or more than two mount brackets 30 may be necessary or sufficient for a particular design application. Each mount bracket is a symmetrical band, has a number of holes and channels 32 that reduce weight and provide multiple locations for attachment to the architectural surface 20 using conventional fasteners, and includes at each opposite end one or more (two are depicted) J-hooks 34.

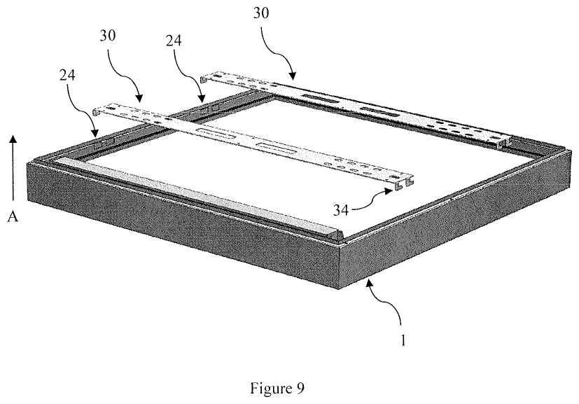

FIG. 9 shows the two mount brackets 30 aligned in the architectural luminaire 1. The side wall 16 of the architectural luminaire 1 has a slot 24 configured to receive a corresponding J-hook 34 of the mount bracket 30. Thus, the total number of slots 24 on the architectural luminaire 1 will typically (although not necessarily) equal the total number of J-hooks 34 on the mounting brackets 30. Eight is the common total number in the embodiment shown in FIG. 9. The side wall 16 of the architectural luminaire 1 is moved into alignment, and ultimately engagement, with the mount brackets 30 in the direction of arrow A in FIG. 9.

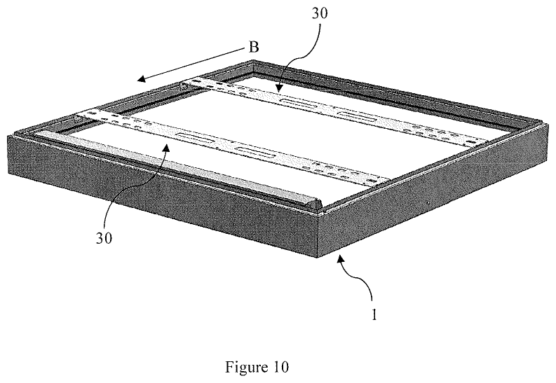

As shown in FIG. 10, once the mount brackets 30 are aligned with the side wall 16 of the architectural luminaire 1 the two components are brought together until each of the J-hooks 34 of the mount brackets 30 is received in a corresponding slot 24 on the side wall 16 of the architectural luminaire 1. The side wall 16 of the architectural luminaire 1 is then slid in the direction of arrow B in FIG. 10 until the J-hooks 34 fully engage the slots 24.

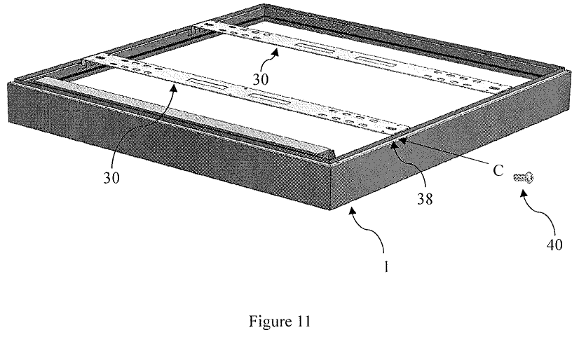

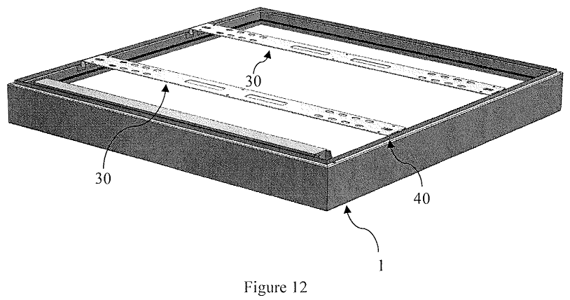

Once the side wall 16 of the architectural luminaire 1 fully engages the mount brackets 30, as shown in FIG. 11, the side wall 16 of the architectural luminaire 1 can be releasably or permanently locked into engagement. Preferably, the side wall 16 of the architectural luminaire 1 is releasably attached to the mount brackets 30 using one or more fasteners such as screws 40. The screws 40 may be moved in the direction of arrow C into corresponding orifices 38 in the side wall 16 of the architectural luminaire 1. FIG. 12 illustrates the side wall 16 of the architectural luminaire 1 attached to the mount brackets 30 with the screws 40 in place.

In summary, the mount brackets 30 allow the architectural luminaire 1 to be mounted easily and quickly to the architectural surface 20 using a few, readily accessible tools (e.g., a screw driver). The mounting brackets 30 support the weight of the architectural luminaire 1. And a simple locking screw 40 is the only hardware required to lock the mount brackets 30 in place as part of the architectural luminaire 1.

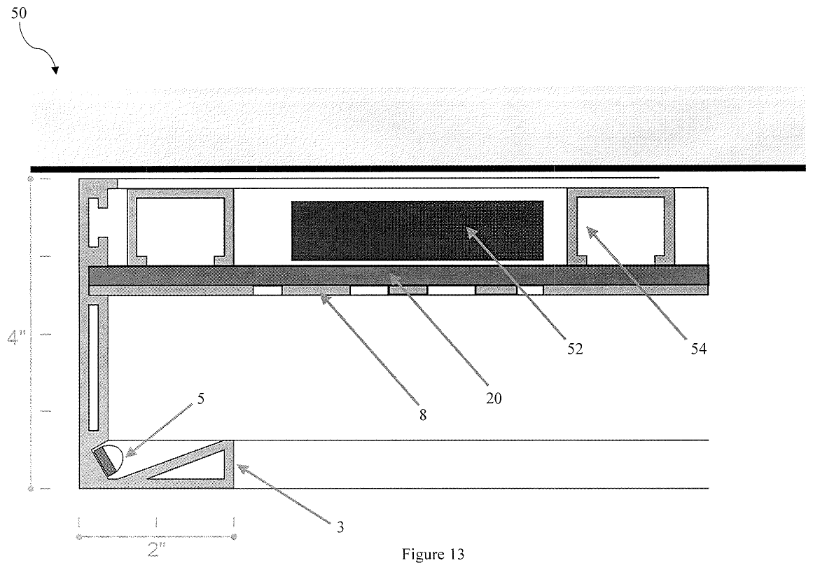

FIG. 13 is a schematic illustrating an embodiment of the architectural luminaire 1 including the lower surface 3 (e.g., a perimeter extrusion), the light source 5, and the decorative feature 8. A suitable but only an example length for the lower surface 3 is about 2 inches (5 cm). The decorative feature 8 is optional and, if included, may be a decorative layer of fabric that is cut using a computer numerical control (CNC) router (which is a computer-controlled cutting machine related to the hand-held router used for cutting various materials). As illustrated, the architectural luminaire 1 is combined with a driver 52 and one or more rigid structures 54 to form an integral lighting unit 50. The lighting unit 50 is attached to the architectural surface 20 such as a ceiling. The rigid structures 54 form a space on the side of the architectural surface 20 opposite the decorative feature 8 to receive the driver 52. A suitable but only an example height for the lighting unit 50 is about 4 inches (10 cm).

In the example shown, the light source 5 is discrete track lighting and, more specifically, an LED tape strip. LED is an acronym for “light emitting diode.” A diode is an electrical component with two terminals which conduct electricity only in one direction. With an electrical current, the diode emits a bright light around a small bulb. LEDs have proven to be the most efficient bulbs available.

LEDs are low-voltage light sources, requiring a constant DC voltage or current to operate optimally. Operating on a low-voltage DC power supply enables LEDs to be easily adapted to different power supplies, permits longer stand-by power, and increases safety. Individual LEDs used for illumination require 2-4 V of direct current (DC) power and several hundred mA of current. As LEDs are connected in series in an array, higher voltage is required. LEDs require a device that can convert incoming AC power to the proper DC voltage and regulate the current flowing through the LED during operation. The driver 52 converts 120 V (or other voltage), 60 Hz AC power to low-voltage DC power required by the LEDs and protects the LEDs from line-voltage fluctuations. The driver 52 is the power supply for the LED system. The driver 52 may be a constant voltage type (usually 10 V, 12 V, or 24 V) or a constant current type (350 mA, 700 mA, or 1 A). Some drivers are manufactured to operate specific LED devices or arrays, while others can operate most commonly available LEDs. The driver 52 is compact enough to fit inside a junction box, includes isolated Class 2 output for safe handling of the load, operates at high system efficiency, and offers remote operation of the power supply.

The driver 52 can enable dimming and color-changing or sequencing of the LEDs. The LEDs are easily integrated with circuits to control dimming and color-changing so that these functions can respond to preset commands or occupant presence or commands. The driver 52 is compatible with commercially available 0-10 V control devices and systems such as occupancy sensors, photocells, wall-box dimmers, remote controls, architectural and theatrical controls, and building and lighting automation systems.

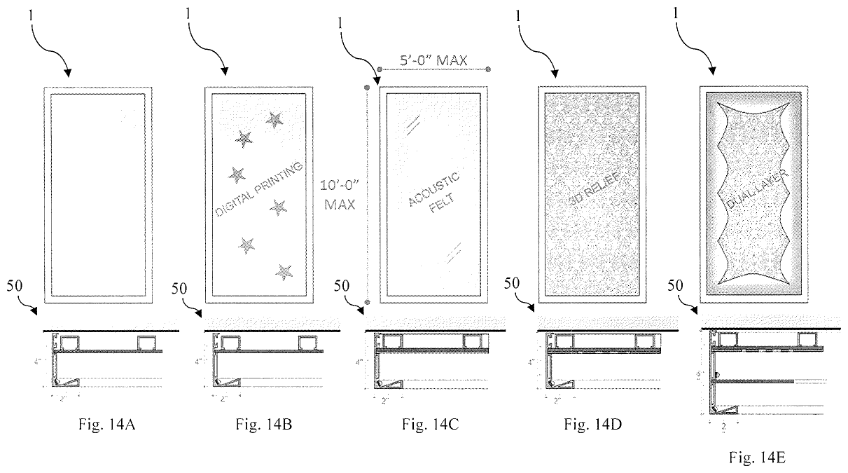

FIGS. 14A, 14B, 14C, 14D, and 14E show various non-limiting options for the aesthetic displays illustrated in a top view of the architectural luminaire 1 (above) and for the corresponding structures of the lighting unit 50 illustrated in a schematic view (below). More specifically, FIG. 14A shows the architectural luminaire 1 having a pure lighting display; FIG. 14B, a decorative art display created by digital printing; FIG. 14C, an acoustic felt display; FIG. 14D, a decorative 3D relief display; and FIG. 14E, a dual layer display. As shown in FIG. 14C, a suitable but only an example length for the architectural luminaire 1 is about 10 feet (305 cm) and a suitable but only an example width for the architectural luminaire 1 is about 5 feet (152.5 cm). FIG. 14E shows an alternative, suitable, but only an example height for the lighting unit 50 is about 6 inches (15 cm) rather than about 4 inches (10 cm) as disclosed above.

### EXAMPLE APPLICATIONS AND DISPLAYS

The following examples are included to more clearly demonstrate the overall nature of the disclosure. These examples are exemplary, not restrictive, of the disclosure.

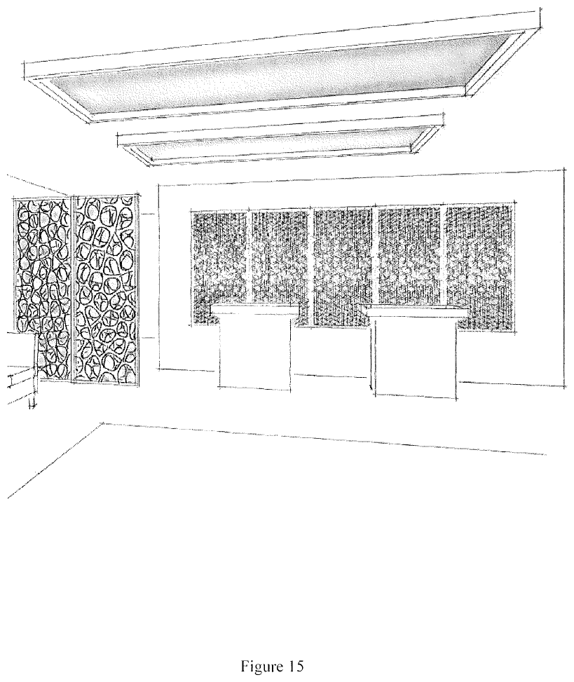

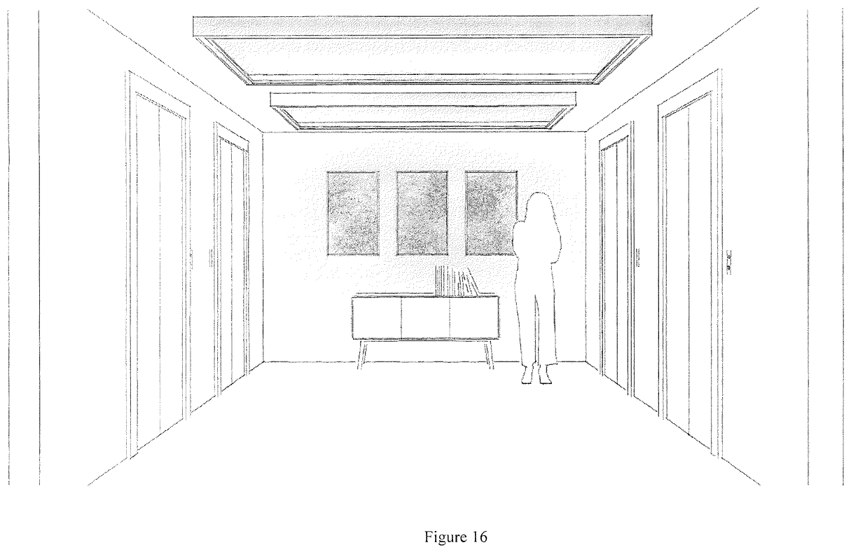

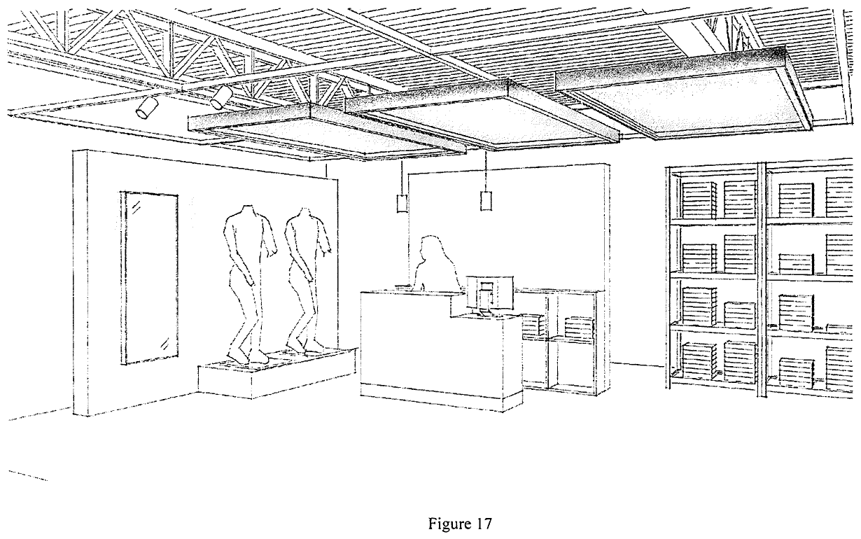

FIG. 15 illustrates three, separate applications (among others possible) for the architectural luminaire 1. As illustrated, the architectural luminaire 1 can be installed on a typical ceiling, on a typical wall, or on a typical room divider. All of the illustrated applications in FIG. 15 are part of a room in a building environment. FIG. 16 illustrates ceiling and wall applications for the architectural luminaire 1 as part of a common area (an elevator lobby) in another building environment. FIG. 17 illustrates a ceiling application for the architectural luminaire 1 as part of a retail space in yet another building environment. Also illustrated in FIG. 17 is a fourth application: installation on a marketing or advertising display in the retail space.

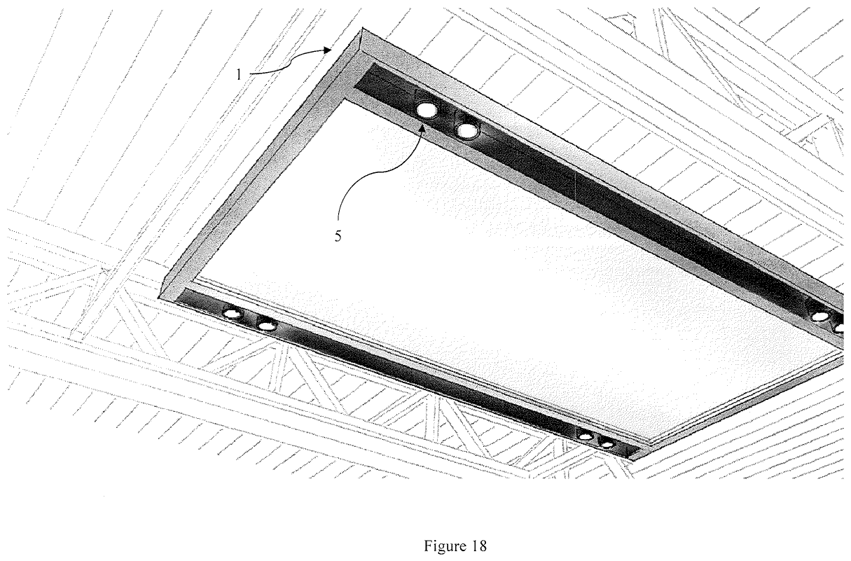

FIG. 18 shows that the architectural luminaire 1 can be installed in open ceiling retail space in a further building environment. The architectural luminaire 1 has discrete track lighting as its light source 5. The architectural luminaire 1 is pre-built and ready to hang, as shown, in the space.

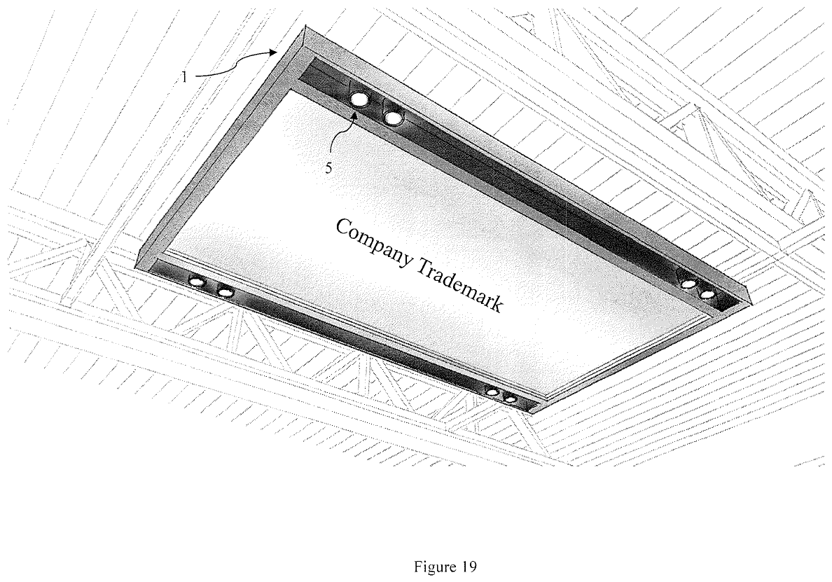

FIG. 19 illustrates one example of how the architectural luminaire 1 shown in FIG. 18 can be customized. Specifically, the display of the architectural luminaire 1 can include any images and indicia (such as company trademarks or logos) desired by creative advertisers. The possibilities are potentially infinite.

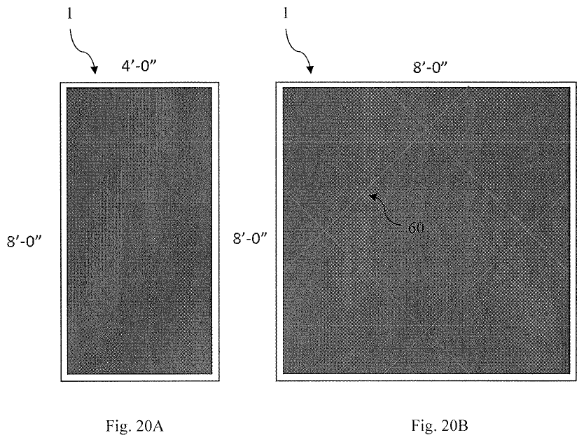

FIG. 20A illustrates an embodiment of the architectural luminaire 1 having a single panel. As shown in FIG. 20A, a suitable but only an example length for the architectural luminaire 1 is about 8 feet (244 cm) and a suitable but only an example width for the architectural luminaire 1 is about 4 feet (122 cm). FIG. 20B illustrates an alternative embodiment of the architectural luminaire 1 having a large format with multiple panels separated by joint lines 60. As shown in FIG. 20B, a suitable but only an example geometry for the architectural luminaire 1 is a square about 8 feet (244 cm) in width and length.

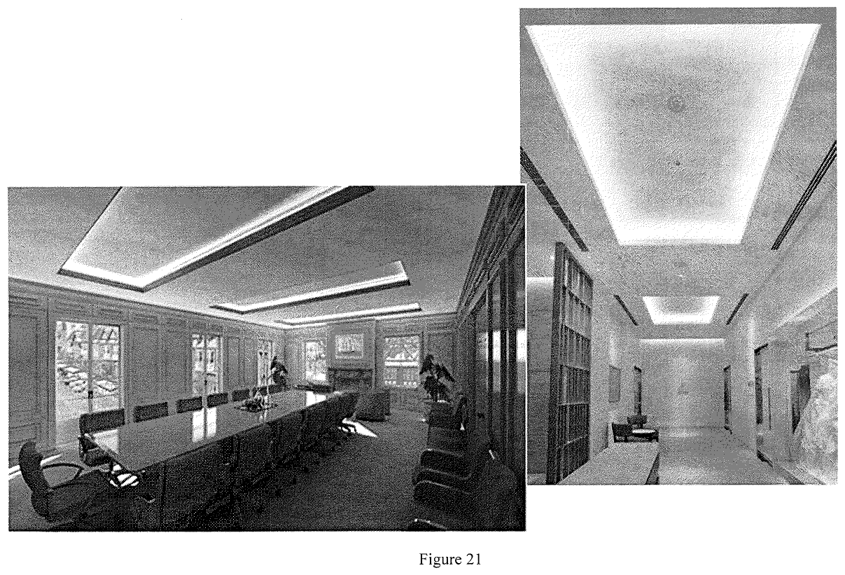

FIG. 21 illustrates an embodiment of the architectural luminaire 1 as installed on a typical ceiling in two different office spaces. The left-hand picture depicts a conference room; the right-hand picture depicts a hallway. Both the conference room and the hallway are part of a building environment.

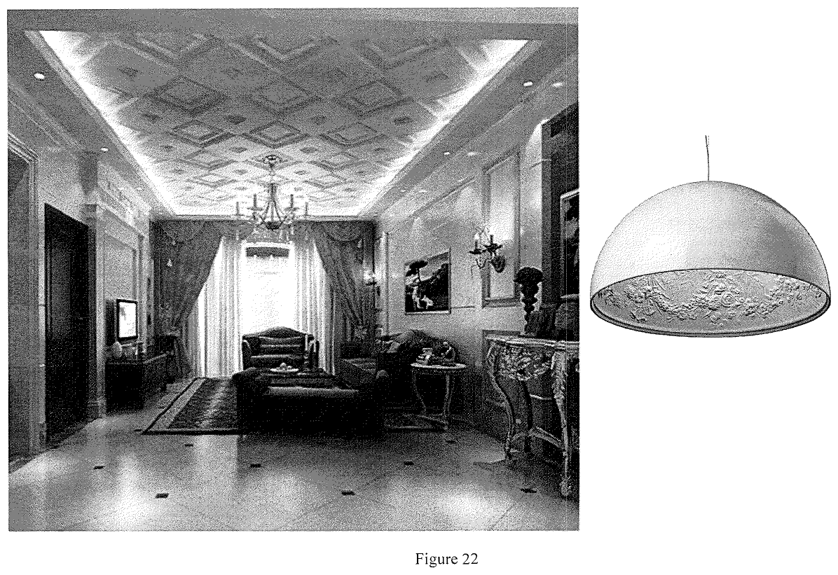

FIG. 22 illustrates an embodiment of the architectural luminaire 1 for which the decorative feature 8 is a shadow 3D relief. The left-hand picture depicts the embodiment installed on a ceiling in a room; the right-hand picture depicts the embodiment hung from a ceiling. The right-hand picture also shows that the architectural luminaire 1 can have round and circular geometries.

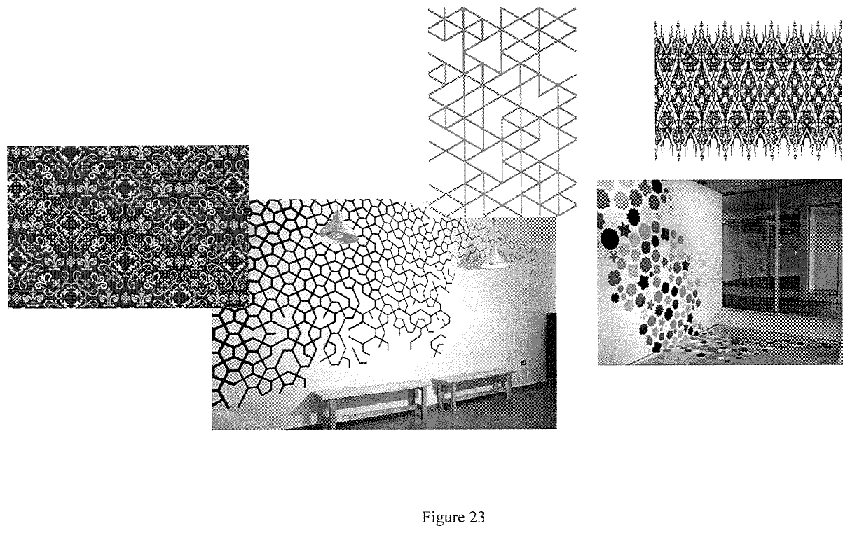

FIG. 23 illustrates five examples of decorative art displays created by digital printing. These displays can form the decorative feature 8 of the architectural luminaire 1.

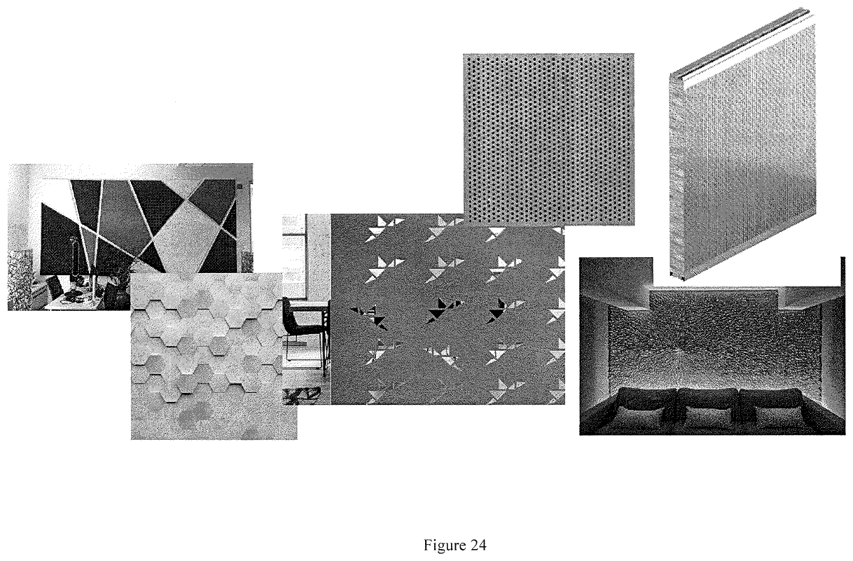

FIG. 24 illustrates six examples of decorative art displays created by fabric layers or perforated ceiling panels. These displays can also form the decorative feature 8 of the architectural luminaire 1.

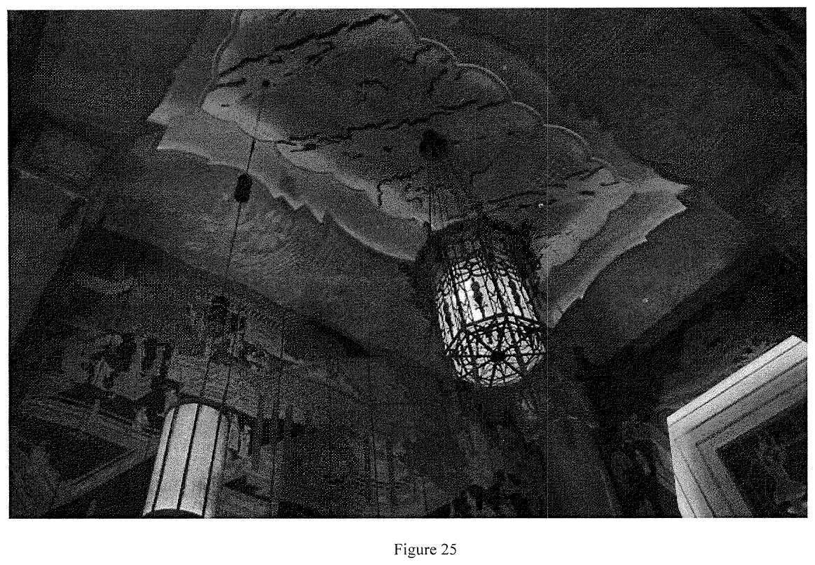

FIG. 25 illustrates an embodiment of the architectural luminaire 1 for which the decorative feature 8 is a colored dual layer display.

The architectural luminaire 1 as described above offers a number of advantages over conventional designs. Among those advantages are use of the architectural luminaire 1 as an architectural feature. The architectural luminaire 1 can fill a space with light while increasing the perception of volume and height. That light imparts a feeling of luxury to a space.

The traditional method of constructing coves as built-in architectural features is costly and inefficient. Complicated framing, gypsum plaster work, and finicky cove lighting makes illuminated ceiling coves costly in new construction and almost impossible to install for retrofits. In contrast, the architectural luminaire 1 as described above saves costs and labor during both construction and installation.

The architectural luminaire 1 as described above is a prebuilt, shallow ceiling cove solution that can be quickly retrofitted onto existing ceilings. The architectural luminaire 1 ensures improved lighting uniformity, straight and true fabrication details, and fast installation. The architectural luminaire 1 additionally comes with unique options like digital printed or 3D relief upper surfaces, dual layer effects, acoustic fabrics, and a variety of light engine options. The architectural luminaire 1 complements an overall lineup of tailored architectural lighting solutions that enable fast retrofits and low cost roll outs of high end luminous design features.

Although illustrated and described above with reference to certain specific embodiments and examples, the present disclosure is nevertheless not intended to be limited to the details shown. Rather, various modifications may be made in the details within the scope and range of equivalents of the claims and without departing from the spirit of the disclosure.

What is claimed:

1. A prefabricated cove luminaire for installation onto ceilings or other architectural surfaces, the cove luminaire comprising:
a mounting mechanism configured to mount the cove luminaire onto the architectural surface;
a lower surface, an upper surface, a side surface extending between the lower surface and the upper surface and separating the lower surface from the upper surface, wherein, in combination, the lower surface, the upper surface, and the side surface define an aperture;
a light source positioned in the aperture and including optics that focus and direct the light rays emanating from the light source in specific patterns to ensure uniformity of the light distribution; and
a decorative feature located proximate or on the upper surface.

2. The prefabricated cove luminaire according to claim 1, wherein the mounting mechanism includes one or more mount brackets having J-hooks and the side surface has a corresponding number of slots configured to receive the J-hooks of the one or more mount brackets.

3. The prefabricated cove luminaire according to claim 1, wherein the cove luminaire has a vertical centerline and is symmetrical about the vertical centerline.

4. The prefabricated cove luminaire according to claim 1, wherein the lower surface has two opposed L-shaped edges defining an opening between the edges and the light source is positioned in the aperture proximate to the L-shaped edges so that the light source is at least partially concelaed byt the lower surface.

5. The prefabricated cove luminaire according to claim 4, wherein the upper surface acts as a reflector for the light rays that emanate from the light source, the upper surface primarily reflecting the light rays through the opening between the edges of the lower surface and out of the architectural luminaire.

6. The prefabricated cove luminaire according to claim 1, further comprising an integral architectural interface engaging the architectural surface.

7. The prefabricated cove luminaire according to claim 1, further comprising a mounting hanger configured to suspend the cove luminaire in open air.

8. The prefabricated cove luminaire according to claim 1, wherein the decorative feature comprises 2D media or 3D shapes.

9. The prefabricated cove luminaire according to claim 8, wherein the decorative feature comprises a lighting display, an art display created by digital printing, a fabric layer, a perforated ceiling panel, a relief display, or a colored dual layer display.

10. The prefabricated cove luminaire according to claim 1, further comprising one or more additional layers located within the aperture, the additional layers creating a dimensional stack of apertures.

11. The prefabricated cove luminaire according to claim 10, wherein each layer of the one or more additional layers has its own light source and individual control as well as its own decorative feature.

12. The prefabricated cove luminaire according to claim 1, wherein the cove luminaire has an outer perimeter and the lower surface has at least one L-shaped edge extending outward away from the side surface and the light source is located proximate to the at least one L-shaped edge so that the light source illuminates the outer perimeter and the architectural surface.

13. The prefabricated cove luminaire according to claim 1, wherein the cove luminaire is configured to be retrofitted onto existing architectural surfaces.

14. A prefabricated cove luminaire for installation onto ceilings or other architectural surfaces, the cove luminaire comprising:
a lower surface, an upper surface, a side surface extending between the lower surface and the upper surface and separating the lower surface from the upper surface, wherein, in combination, the lower surface, the upper surface, and the side surface define an aperture;
a mounting mechanism configured to mount the cove luminaire onto the architectural surface, the mounting mechanism including one or more mount brackets having J-hooks and a corresponding number of slots in the side surface configured to receive the J-hooks of the one or more mount brackets;
a light source positioned in the aperture and including optics that focus and direct the light rays emanating from the light source in specific patterns to ensure uniformity of the light distribution; and
a decorative feature located proximate or on the upper surface, the decorative feature comprising 2D media or 3D shapes,
wherein the cove luminaire is configured to be retrofitted onto existing architectural surfaces.

15. An integral lighting unit for installation onto ceilings or other architectural surfaces, the unit comprising:
a prefabricated cove luminaire having (a) a lower surface, an upper surface, a side surface extending between the lower surface and the upper surface and separating the lower surface from the upper surface, wherein, in combination, the lower surface, the upper surface, and the side surface define an aperture, (b) a light source positioned in the aperture and including optics that focus and direct the light rays emanating from the light source in specific patterns to ensure uniformity of the light distribution, and (c) a decorative feature located proximate or on the upper surface;
one or more rigid structures forming a space on the side of the upper surface opposite the decorative feature; and
a driver located in the space and providing power to the unit.

16. The integral lighting unit according to claim 15, wherein the light source is discrete track lighting.

17. The integral lighting unit according to claim 16, wherein the light source is a plurality of light emitting diodes.

18. The integral lighting unit according to claim 17, wherein the driver enables dimming and color-changing or sequencing of the light emitting diodes.

19. The integral lighting unit according to claim 15, wherein the decorative feature comprises 2D media or 3D shapes.

20. The integral lighting unit according to claim 19, wherein the decorative feature comprises a lighting display, an art display created by digital printing, a fabric layer, a perforated ceiling panel, a relief display, or a colored dual layer display.
